(19) United States
(12) Patent Application Publication
(10) Pub. No.: US 2020/0402689 A1
(43) Pub. Date: Dec. 24, 2020

(54) AN EXTERNALLY CONTROLLED THERMAL TRIP DEVICE, METHOD AND APPLICATION FOR VARISTORS

(71) Applicants: Shanghai ASP Lighting Protective Technology Co., Ltd., Pudong New District, Shanghai (CN); MERSEN USA EP Corp., Boonton, NJ (US)

(72) Inventor: Ting PAN, Xi'an, Shaanxi (CN)

(73) Assignees: Shanghai ASP Lighting Protective Technology Co., Ltd., Pudong New District, Shanghai (CN); MERSEN USA EP Corp., Boonton, NJ (US)

(21) Appl. No.: 16/956,737

(22) PCT Filed: Jan. 22, 2018
(86) PCT No.: PCT/CN2018/073637

§ 371 Date: Jun. 22, 2020

(51) Int. Cl. H01C 7/12; H01C 13/02

(52) U.S. Cl. CPC H01C 7/12; H01C 13/02

(57) ABSTRACT

An externally-controllable thermal tripping device comprising a voltage dependent resistor including a voltage dependent resistor chip; a thermal tripper including a tripping electrode; and a controllable heating element. The tripping electrode is connected to an electrode of the voltage dependent resistor chip through a meltable welding material, and the controllable heating element is controlled by an external control device to generate heat and transmit generated heat to a commissure of said welding material to melt said welding material and electrically disconnect the tripping electrode from the voltage dependent resistor chip.

### BACKGROUND OF THE INVENTION

### Field of the Invention

The present invention relates to a technology of a voltage dependent resistor, particularly to an externally-controllable thermal tripping device applicable to a voltage dependent resistor, a method of operating the same and an application of the same.

### Description of the Related Art

As voltage dependent resistors (VDR) can prevent apparatuses from being damaged by overvoltage, such as lightning or overvoltage in a power grid, they are widely applied to various fields. However, aging VDR may short-circuit, failing to work and inducing a fire. Therefore, failure and short circuit of VDR should be controlled in time. There is a technology, i.e. the safety VDR, available in the market, including the thermal protection VRD and the thermally protected metal-oxide varistor (TPMOV), wherein VDR generates heat before failure; the generated heat is used to melt the connection between VDR and the circuit, whereby the current is cut off. Besides, another technology uses a thermal tripping structure to form a surge protection device (SPD), which can provide a tripping instruction. The thermal protection part of the related device absorbs the heat generated by VDR and cuts off the circuit before VDR catches fire. Thereby, VDR can protect other electronic devices, and the safety of VDR application is enhanced. Below, the application of VRD in surge protection devices (SPD) is used to explain the function of VDR.

The short-circuit protection function of SPD uses a thermal protection tripper and a VDR chip (metal oxide varistor, MOV) to cut off power. While the temperature of the deteriorated electrode of MOV rises to a specified value, the meltable material of the thermal protection tripper is melted to guarantee that the tripper has cut off power before the housing of SPD is burned. Therefore, the power would not be cut off unless MOV has deteriorated and the leakage current is large enough to generate so high a temperature that the meltable material melts. Before the abovementioned case, while the leakage current of the deteriorated MOV is still insufficient to melt the low-temperature welding material, lightning or overvoltage is likely to directly puncture MOV and result in short circuit. The short-circuited MOV has almost zero resistance. Therefore, leakage current or malfunction current would not generate heat in the short-circuited MOV. Consequently, the tripper fails to work, and a fire may occur.

### SUMMARY OF THE INVENTION

The present invention provides an externally-controllable thermal tripping device applicable to a VDR, a method of operating the same and an application of the same to overcome the conventional problems of VDR.

According to a first aspect, in one embodiment, the present invention provides an externally-controllable thermal tripping device applicable to VDR, which comprises a VDR chip and a thermal tripper and is characterized in further comprising a controllable heating element,

wherein a tripping electrode of the thermal tripper is connected to an electrode of the VDR chip through a meltable welding material, and

wherein the controllable heating element is controlled by an external control device to generate heat and transmits the generated heat to a commissure of the meltable welding material to melt the meltable welding material and make the tripping electrode of the thermal tripper electrically disconnected from the VDR chip.

In one embodiment, the external control device controls the controllable heating element to generate heat according to a condition that the VDR chip malfunctions and/or an element deteriorates, or a preset condition.

In one embodiment, the controllable heating element and the thermal tripper are fabricated into an integral structure.

In one embodiment, the controllable heating element and the thermal tripper are connected to each other in a dismountable way.

In one embodiment, the commissure between the controllable heating element and the meltable welding material is formed by heat conduction.

In one embodiment, the thermal tripping device of the present invention is characterized in further comprising at least one temperature sensor, wherein the temperature sensor is disposed at a position where a surface temperature of the VDR chip can be measured and/or a position where a temperature of the controllable heating element can be measured.

In one embodiment, the thermal tripping device of the present invention is characterized in further comprising a separating plate, wherein the separating plate is disposed between the tripping electrode of the thermal tripper and the VDR chip, and wherein the controllable heating element transmits heat to the commissure of the meltable welding material, and wherein while the meltable welding material is melted, the separating plate is pushed into a position between the tripping electrode of the thermal tripper and the electrode of the VDR chip to make the tripping electrode of the thermal tripper electrically disconnected from the VDR chip.

According to a second aspect, in one embodiment, the present invention provides a method of operating an externally-controllable thermal tripping device applicable to a VDR, which comprises steps:

disposing a controllable heating element, which can be controlled externally, inside the VDR;

controlling the controllable heating element to generate heat;

the controllable heating element transmitting heat to a commissure of a meltable welding material inside the VDR; and

the VDR actively performing thermal separating while the meltable welding material is melted.

In one embodiment, the VDR is a voltage dependent resistor including the abovementioned externally-controllable thermal tripping device.

In an aspect of cooperative manufacturers, the present invention provides an application of a VDR, wherein the VDR includes the abovementioned externally-controllable thermal tripping device and is applicable to thermal protection apparatuses.

According to the abovementioned embodiments of the externally-controllable thermal tripping device, the external control device can control the controllable heating element to generate heat autonomously, whereby the thermal tripper can be actively separated from the VDR chip. For example, while the VDR chip deteriorates or another element ages, the external control device controls the controllable heating element to generate heat to melt the meltable welding material and make the thermal tripper separated from the VDR chip. Thereby, the safety and reliability of the apparatus using the VDR is enhanced.

### BRIEF DESCRIPTION OF THE DRAWINGS

FIG. 1 is a diagram schematically showing an interior structure of an externally-controllable thermal tripping device according to one embodiment of the present invention;

FIG. 2 is a diagram schematically showing an interior structure of an externally-controllable thermal tripping device according to another embodiment of the present invention;

FIG. 3 is a diagram schematically showing a naked design of an externally-controllable thermal tripping device according to one embodiment of the present invention;

FIG. 4 is a diagram schematically showing a structure of a thermal tripper of an externally-controllable thermal tripping device according to one embodiment of the present invention;

FIG. 5 is a diagram schematically showing a structure of a thermal tripper of an externally-controllable thermal tripping device according to another embodiment of the present invention;

FIG. 6 is a diagram schematically showing disconnection of a thermal tripper and a VDR chip according to one embodiment of the present invention;

FIG. 7 is a diagram schematically showing disconnection of a thermal tripper and a VDR chip according to another embodiment of the present invention;

FIG. 8 is a diagram schematically showing disconnection of a thermal tripper and a VDR chip according to still another embodiment of the present invention; and

FIG. 9 is a diagram schematically showing that an externally-controllable thermal tripping device is applied to a circuit according to one embodiment of the present invention.

### DETAILED DESCRIPTION OF THE INVENTION

Below, embodiments are described in detail in cooperation with the attached drawings to further demonstrate the present invention.

The present invention provides an externally-controllable thermal tripping device applicable to a VDR, which is characterized in an active and controllable tripping technology of a VDR, to overcome the safety problems resulting from the conventional passive tripping technology.

In one embodiment, the externally-controllable thermal tripping device comprises a VDR chip 1, a thermal tripper 2 and a controllable heating element 3. A tripping electrode 21 of the thermal tripper 2 is connected to an electrode 11 of the VDR chip 1 through a meltable welding material 4. For example, the welding material 4 is a low-temperature solder; the tripping electrode 21 of the thermal tripper 2 is welded to the electrode 11 of the VDR chip 1 through the low-temperature solder. The controllable heating element 3 is controlled by an external control device to generate heat. For example, the external control device controls the controllable heating element 3 to generate heat according to a condition that the VDR chip 1 malfunctions and/or an element deteriorates. Therefore, the controllable heating element 3 can actively generates heat according to a condition that the VDR chip 1 malfunctions and/or an element deteriorates. For an example, the external control terminal may actively control the controllable heating element 3 to generate heat according to the detected malfunction current of the VDR 1. For another example, the external terminal may actively control the controllable heating element 3 to generate heat according to the detected deterioration of other elements. For a further example, the external terminal may actively control the controllable heating element 3 to generate heat according to a preset condition. The preset condition may be a special requirement of a user. Thereby, the controllable heating element 3 may be controlled to generate heat actively. The controllable heating element 3 transmits the generated heat to a commissure of the welding material 4 to melt the welding material 4, whereby the tripping electrode 21 of the thermal tripper 2 is electrically disconnected from the VDR chip 1. Therefore, the externally-controllable thermal tripping device can indeed realize a tripping function.

According to the abovementioned design, the disconnection of the thermal tripper from the VDR chip 1 can be controlled actively in the present invention. In the present invention, the disconnection of the thermal tripper from the VDR chip 1 is via controlling the controllable heating element 3 to generate heat to melt the welding material 4. The conventional technology uses the malfunction current of the VDR chip to generate heat and melt the welding material 4. If the VDR chip 1 has been deteriorated, the leakage current thereof is not necessarily sufficient to melt the welding material 4. In such a case, if the VDR chip 1 suffers a lightning stroke or experiences overvoltage, the VDR chip 1 may break down and short-circuit. The resistance of the short-circuited VDR chip 1 is almost zero, and the short-circuited VDR chip 1 does not generate heat for leakage current or malfunction current. It may make the tripper fail to work and cause a fire. In the present invention, the disconnection of the thermal tripper from the VDR chip 1 is via controlling the controllable heating element 3 to generate heat to melt the welding material 4. Therefore, the present invention can prevent from the fire caused by the failure of the tripper, the fire caused by incomplete disconnection of the thermal tripper 2, the fire caused by unsuccessful disconnection resulting from that tremendous short-circuit current damages the physical structure of the thermal tripper 2 before the thermal tripper 2 completes its operation, and the fire caused by that the deteriorated element makes the external apparatus, which is connected with the VDR, unable to separate from the main power source.

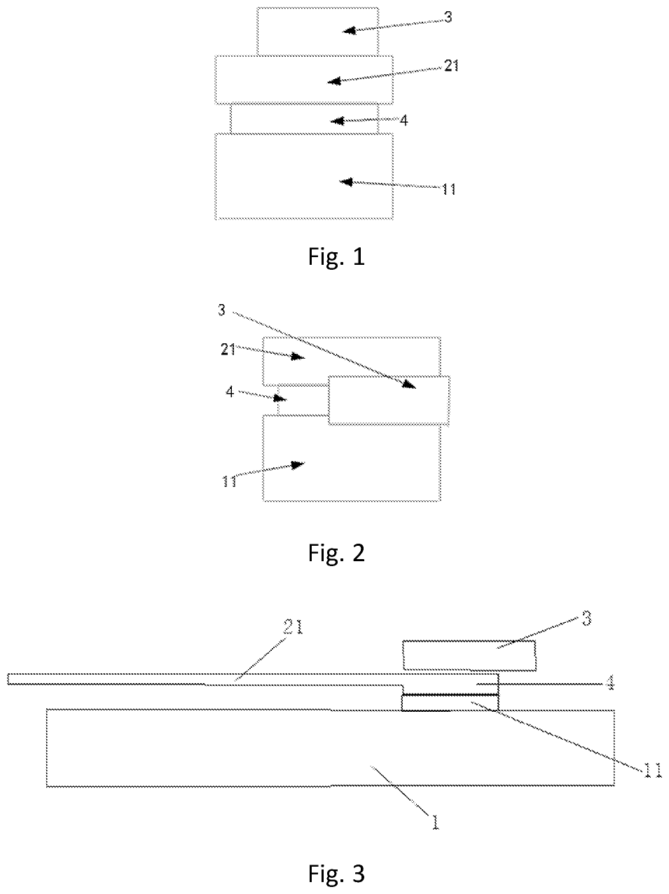

In order to achieve the target of the present invention, the commissure between the controllable heating element 3 and the welding material 4 should have superior thermal conductivity. Refer to FIG. 1. In one embodiment, the controllable heating element 3 is disposed above the tripping electrode 21 and very near the welding material 4. Refer to FIG. 2. In one embodiment, the controllable heating element 3 is disposed beside the welding material 4 and directly contacts the welding material 4. The present invention does not particularly limit the position of the controllable heating element 3 as long as the commissure between the controllable heating element 3 and the welding material 4 have superior thermal conductivity. In the present invention, the controllable heating element 3 may be a thermistor, a ceramic heater or another heat generating material, such as a mica heater or an electric heating filament.

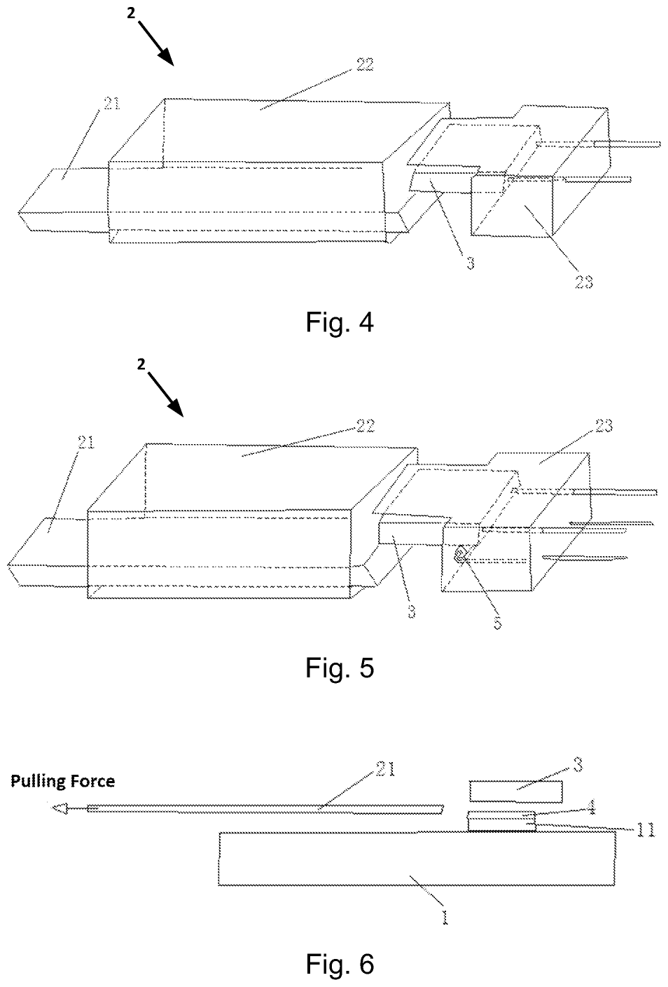

Refer to FIG. 3. In a practical application, the controllable heating element 3, the tripping electrode 21, the welding material 4, and the electrode 11 of the VDR chip 1 are jointly fabricated into a naked structure. In another embodiment, the thermal tripper 2 is provided with a housing, and the controllable heating element 3 and the thermal tripper 2 is configured to be an integral structure. Refer to FIG. 4. The thermal tripper 2 further comprises a first housing 22 and a second housing 23. The tripping electrode 21 is inserted into the first housing 22, and the controllable heating element 3 is inserted into the second housing 23, and then the first housing 21 and the second housing 23 are joined in an inserting way to form an integral structure, whereby the integration of elements is realized.

In another embodiment, the controllable heating element 3 and the thermal tripper 2 are connected in a detachable way, whereby the elements can be changed conveniently.

In order to control the controllable heating element 3 more effectively, the present invention further comprises a temperature sensor 5. The temperature sensor 5 is disposed at a position where a surface temperature of the VDR chip 1 can be measured and/or a position where a temperature of the controllable heating element 3 can be measured. Refer to FIG. 5, wherein the temperature sensor 5 is disposed at a position where a temperature of the controllable heating element 3 can be measured. In the embodiment shown in FIG. 5, the temperature sensor 5 is inserted into the second housing 23 and disposed below the controllable heating element 3, and the temperature sensor 5 has signal communication with the external control device. Thereby, the external control device can control the controllable heating element 3 to generate heat according to the SPD (Surge Protection Device) temperature fed back by the temperature sensor 5. The temperature sensor 5 may be an NTC (Negative Temperature Coefficient) temperature measurement element.

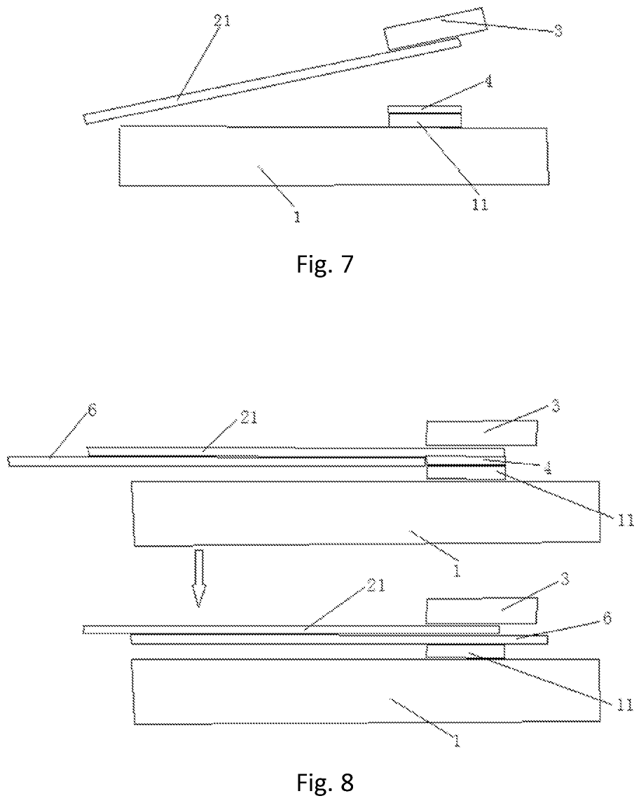

Refer to FIG. 6 and FIG. 7. While the welding material 4 is melted by the heat coming from the controllable heating element 3, an external pulling force will separate the thermal tripper 2 from the VDR chip 1. Refer to FIG. 8. While the welding material 4 is melted by the heat coming from the controllable heating element 3, the thermal tripper 2 may be separated from the VDR chip 1 by an external pushing force. It should be further explained: the present invention does not restrict that the thermal tripper 2 must be separated from the VDR chip 1 by a pulling force or a pushing force. In the present invention, the thermal tripper 2 may be separated from the VDR chip 1 by another force, such as an elastic force.

While an external pushing force is used to separate the thermal tripper 2 from the VDR chip 1, it is preferred: the present invention further comprises at least one separating plate 6. The separating plate 6 is disposed between the tripping electrode 21 of the thermal tripper 2 and the VDR chip 1, and the commissure of the welding material 4 hinders the separating plate 6 from separating the thermal tripper 2 and the VDR chip 1. In such a case, the external control device may control the controllable heating element 3 to generate heat to the commissure of thee welding material 4; while the welding material 4 is melted, the separating plate 6 is pushed to a position between the tripping electrode 21 of the thermal tripper 2 and the electrode 11 of the VDR chip 1, whereby the tripping electrode 21 of the thermal tripper 2 is electrically disconnected from the VDR chip 1. Thus, the separating plate 6 completes the separating function and separates the thermal tripper 2 from the VDR chip 1.

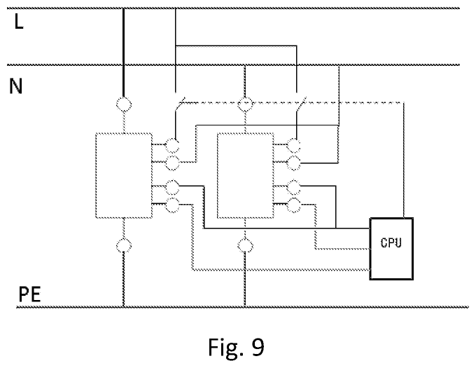

Refer to FIG. 9 for a circuit using the externally-controllable thermal tripping device of the present invention, wherein the external control device, such as CPU, actively controls the controllable heating element 3 to generate heat to melt the welding material 4 and thus realize the target of separating the thermal tripper 2 from the VDR chip 1.

The structure of the externally-controllable thermal tripping device applicable to VDR of the present invention has been described above. The method for externally controlling a thermal tripping device applicable to VDR of the present invention will be described below. In one embodiment, the method of the present invention comprises the following steps:

disposing controllable heating element 3, which can be controlled externally, inside VDR;

controlling the controllable heating element 3 to generate heat; for example, controlling the controllable heating element 3 to generate heat according to a condition that the VDR chip 1 malfunctions and/or an element deteriorates, or a preset condition;

the controllable heating element 3 transmitting heat to a commissure of a meltable welding material inside VDR; and

VDR actively performing thermal separating while the meltable welding material is melted.

In the present invention, VDR is a voltage dependent resistor having the abovementioned externally-controllable thermal tripping device, such as a thermally-protected VDR or a thermally-protected metal oxide varistor (TPMOV).

Based on the abovementioned externally-controllable thermal tripping device and the method of operating the same, the present invention further provides an application of VDR, wherein the VDR includes the abovementioned externally-controllable thermal tripping device and is applicable to thermal protection apparatuses, such surge protection devices and fuse blocks.

The embodiments have been used to demonstrate the present invention hereinbefore. However, these embodiments are only to exemplify and explain the present invention but not to limit the scope of the present invention. According to the specifications and the claims of the present invention, the persons skilled in the art should be able to make substitutions, modifications and variations in the embodiments of the present invention without departing from the spirit and scope of the present invention.

1. An externally-controllable thermal tripping device comprising:
a voltage dependent resistor including a voltage dependent resistor chip;
a thermal tripper including a tripping electrode; and
a controllable heating element,
wherein the tripping electrode of said thermal tripper is connected to an electrode of said voltage dependent resistor chip through a meltable welding material, and
wherein said controllable heating element is controlled by an external control device to generate heat and transmit generated heat to a commissure of said welding material to melt said welding material and make said tripping electrode electrically disconnected from said voltage dependent resistor chip.

2. The externally-controllable thermal tripping device according to claim 1, wherein said controllable heating element is controlled to generate heat in response to a condition that said voltage dependent resistor chip malfunctions and/or an element deteriorates, or a preset condition.

3. The externally-controllable thermal tripping device according to claim 1, wherein said controllable heating element and said thermal tripper form an integral structure.

4. The externally-controllable thermal tripping device according to claim 1, wherein said controllable heating element and said thermal tripper are connected to each other in a dismountable way.

5. The externally-controllable thermal tripping device according to claim 3, wherein said commissure between said controllable heating element and said welding material is formed by heat conduction.

6. The externally-controllable thermal tripping device according to claim 1 further comprising:
at least one temperature sensor, wherein said at least one temperature sensor is disposed at a position where a surface temperature of said voltage dependent resistor chip can be measured and/or a position where a temperature of said controllable heating element can be measured.

7. The externally-controllable thermal tripping device according to claim 1 further comprising:
a separating plate disposed between said tripping electrode of said thermal tripper and said voltage dependent resistor chip, and
wherein said controllable heating element transmits heat to said commissure of said welding material, and
wherein while said welding material is melted, said separating plate is pushed into a position between said tripping electrode of said thermal tripper and said electrode of said voltage dependent resistor chip to make said tripping electrode of said thermal tripper electrically disconnected from said voltage dependent resistor chip.

8. A method of operating an externally-controllable thermal tripping device applicable to a voltage dependent resistor, said method comprising:
disposing a controllable heating element, which can be controlled externally, inside said voltage dependent resistor;
controlling said controllable heating element to generate heat;
said controllable heating element transmitting heat to a commissure of a meltable welding material inside said voltage dependent resistor; and
said voltage dependent resistor actively performing thermal separating while said meltable welding material is melted.

9-10. (canceled)

11. The externally-controllable thermal tripping device according to claim 4, wherein said commissure between said controllable heating element and said welding material is formed by heat conduction.
